(19) United States
(12) Patent Application Publication
(10) Pub. No.: US 2003/0028441 A1
(43) Pub. Date: Feb. 6, 2003

(54) Answer fulfillment-based marketing

(75) Inventors: Eric Lawrence Barsness, Pine Island, MN (US); John Matthew Santosuosso, Rochester, MN (US)

Correspondence Address: Scott A. Stinebruner, Wood, Herron & Evans, L.L.P., 2700 Carew Tower, 441 Vine Street, Cincinnati, OH, 45202-2917, US

(73) Assignee: INTERNATIONAL BUSINESS MACHINES CORPORATION, Armonk, NY

(21) Appl. No.: 09/921,332

(22) Filed: Aug. 2, 2001

(51) Int. Cl. G06F 17/60

(52) U.S. Cl. 705/26

(57) ABSTRACT

An apparatus, program product, and method utilize the concept of answer fulfillment as a mechanism to direct advertisements to targeted individuals. In particular, electronic messages, typically accessed from one or more electronic message repositories representative of one or more electronic communities, are electronically analyzed to locate a message that incorporates a query directed to a particular topic of interest. Then, after locating such a message, another electronic message is sent, including both a reply to the query and an advertisement related to the topic of interest to which the query is directed. The electronic message may be sent directly to the originator of the query, or may be sent so as to make the message available to other potential advertisement recipients. Moreover, the reply to the query may include an answer to the query, or may simply direct a recipient to where an answer may be obtained.

### FIELD OF THE INVENTION

The invention is generally related to computers and computer software, and in particular to computer-assisted advertising and marketing.

### BACKGROUND OF THE INVENTION

The Internet has grown at a remarkable pace, and has become firmly entrenched in nearly all aspects of society. Whereas the Internet initially was limited to purely academic and government endeavors, the Internet has now become an important avenue of commercial activity, not to mention an important source of educational, commercial and entertainment-related information. Moreover, in addition to simply operating as a source of information, the Internet provides a mechanism for bringing together individuals and entities from across the globe. As an example, for business enterprises, the Internet provides the ability to interact electronically with customers, as well as suppliers, distributors and other business partners. Even in non-commercial areas, the Internet enables individuals sharing common interests and avocations to interact and share information with one another.

Of particular importance, the Internet often provides individuals with the ability to interact with one another to facilitate the exchange and dissemination of information, and in particular to bring together individuals that have specific questions with those who potentially can answer those questions. In many instances, individuals are permitted to send queries that are directed to no particular individuals, but are viewed by other individuals with the hope that an individual that ultimately views a query will be able to respond with an appropriate answer to that query.

Interaction between such individuals via the Internet is predominantly supported through a number of different types of on-line or electronic “communities” or discussion areas with which such individuals may participate. For example, one type of electronic community supported by the Internet is a forum, also typically referred to as a newsgroup, a discussion group, a message board, or a usenet group. A typical forum is directed to some topic of interest, which may be relatively broad (e.g., “cooking”) or relatively narrow (e.g., “Cajun cooking recipes”). Often, related forums are grouped together and managed by a specific Internet site. On a typical forum, individuals are permitted to send messages that are “posted” for other individuals to view. The messages are typically organized into “threads”, which are typically directed to specific issues that pertain to the general topic of interest for a forum. A message may constitute the first message in a thread, such that any reply messages posted in response to that message will be automatically incorporated into the thread, and often displayed in conjunction with all of the other messages in that thread in chronological order. Thus, for example, an individual might create a new thread in a cooking forum with a message requesting a good recipe for jambalaya. Presumably, other messages in that thread would provide recipes that satisfied that original request. An important aspect of a forum is that many individuals that do not actually participate in a thread will often view the thread as well. Consequently, in many cases individuals often can find answers to their questions by looking for earlier threads that may have already addressed their particular question.

Another type of electronic community is a listserv or mailing list, which typically relies upon a distribution list of email addresses for the members of the mailing list to forward email messages directed to the mailing list to all of the members of that list. Thus, any subscribed members will receive, either on a message-by-message basis, or in a digest form, a copy of all email directed to an email address associated with the list. Mailing lists are often associated with particular topics of interest as well, and as such, an individual wishing to pose questions to a mailing list would typically send a message to an email address for the mailing list. Any replies to the question would then be supplied in further email messages sent by other individuals to the list, and likewise distributed to all list members.

Yet another type of electronic community is a chat room, which is a fairly “real-time” community where a running conversation is displayed to individuals. Often, individuals must “log in” to a chat room, and once logged in, those individuals are permitted to both type text messages, which are automatically forwarded to the chat room for display to other logged in individuals, and view the text messages of others.

As mentioned above, in addition to the aforementioned educational and informational benefits, the Internet has also become important in connection with commercial endeavors. In particular, the Internet has become an important medium through which commercial entities can effectively market their goods and services to potential customers. Electronic dissemination of advertisements is both fast and relatively inexpensive, since the context is often purely digital in nature. Unsolicited, direct market email messages, for example, can often be sent to thousands or millions of individuals at a time for extremely low cost to the advertiser.

Of course, directing unsolicited email messages to many individuals is analogous to the “junk” mail that individuals often receive via postal mail, and is often perceived by many recipients in a negative fashion. In fact, unsolicited email has earned the unflattering moniker of “spam” throughout the digital world. Further, great efforts have been directed toward the development of filtering programs that attempt to block unsolicited email messages from reaching individuals, based on the flood of such email messages that many individuals receive each day.

On the other hand, it has been found that the information that is stored and transmitted over the Internet, including archived messages and the like, is inherently trackable and capable of being analyzed through computer analysis techniques. As a result, significant efforts have also been directed toward utilizing computer analysis to increase the efficacy of marketing campaigns, e.g., by locating individuals that would most likely be receptive to an advertisement, by tailoring advertisements to maximize their positive impression on particular individuals, etc.

As an example, many individuals rely on search engines or directories to assist them in locating sources of desired information. With a search engine or directory, an individual that is seeking information transmits a collection of keywords or other search parameters, receiving in return results in the form of a list of sources of information that potentially meet the transmitted search parameters. In some instances, individuals are able to input a search request in the form of a natural language question, e.g., “what is a good recipe for jambalaya?”

In connection with the results, many search engines and directories also transmit advertisements. In some instances, computer analysis has been utilized in connection with search engines and directories to improve the efficacy of such advertisements by attempting to select advertisements based upon the search parameters input by an individual. Thus, for example, if an individual inputs the search terms “recipe” and “jambalaya,” a search engine might return, along with the results, an advertisement for a recipe book, whereas if an individual inputs a search term such as “HDTV,” the individual might receive an advertisement for a consumer electronics retailer in connection with the results.

While tailoring advertisements to search results permits generally more effective advertising than unsolicited direct marketed messages, many individuals do not rely heavily on search engines or directories to locate information. Rather, many individuals prefer to locate information using the expertise of other individuals, e.g., through interaction in the aforementioned electronic communities. In such instances, search engine-based advertising does not reach those individuals. Furthermore, while advertisements may be displayed in connection with electronic communities, those advertisements are usually directed to the overall general area of interest for the community (e.g., consumer electronic retailer ads on a home theater forum), and not in response to particular questions or issues raised by particular individuals. Advertisements also are sometimes posted to an electronic community (e.g., by sending spam to a mailing list); however, such advertisements are often unfocused and considered to be intrusive by their recipients, and may in some instances do more to alienate individuals than promote a positive impression for a product or service being advertised.

Therefore, a need exists in the art for an improved manner of targeting electronic advertising to individuals in a non-intrusive manner, in particular to improve the marketing efficacy of such advertisements.

### SUMMARY OF THE INVENTION

The invention addresses these and other problems associated with the prior art by providing an apparatus, program product, and method in which the concept of answer fulfillment is used as a principal mechanism to direct advertisements to particular individuals. In particular, electronic messages associated with one or more electronic communities are electronically analyzed to locate a message that incorporates a query directed to a particular topic of interest. Then, after locating such a message, another electronic message is sent, including both a reply to the query and an advertisement related to the topic of interest to which the query is directed.

Given that advertising is typically most effective when the recipients of an advertisement have a particular need or desire for a product or service being advertised, it is believed that generating both a reply to a query and an advertisement related to the same topic of interest as for the query provides a relatively effective manner of targeting advertisements to relatively receptive individuals. Moreover, the provision of a reply to a query in connection with an advertisement is believed to impress some degree of goodwill toward an individual seeking an answer to a particular query, and thus further increase the likely receptiveness of that individual to an advertisement.

By way of example, and without intending to limit the scope of the invention, consider a query posed in a post made to a forum related to a topic of interest such as cooking, e.g., “does anyone have a recipe for jambalaya?”. Text analysis techniques may be used to detect that the post incorporates a query, as well as to what the query is likely directed. A suitable message sent in response to such a query by an embodiment consistent with the invention therefore might be “There is a great recipe for jambalaya in Bob's Cajun Cooking Database, which can be found at http://www.BobsCajunCooking.com,” or even “Here's a great recipe for jambalaya . . . [recipe] . . . You can find this and other great recipes in Bob's Cajun Cooking Database, which can be found at http://www.BobsCajunCooking.com.” In the former instance, the reply provides only the directions on how to retrieve a suitable answer to the query, while in the latter instance, the reply actually includes a suitable answer. In either scenario, however, the advertising portion of the message is coupled with a reply to the query, and as such, it is believed that a favorable overall impression will often result from the message.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention. BRIEF DESCRIPTION OF THE DRAWINGS

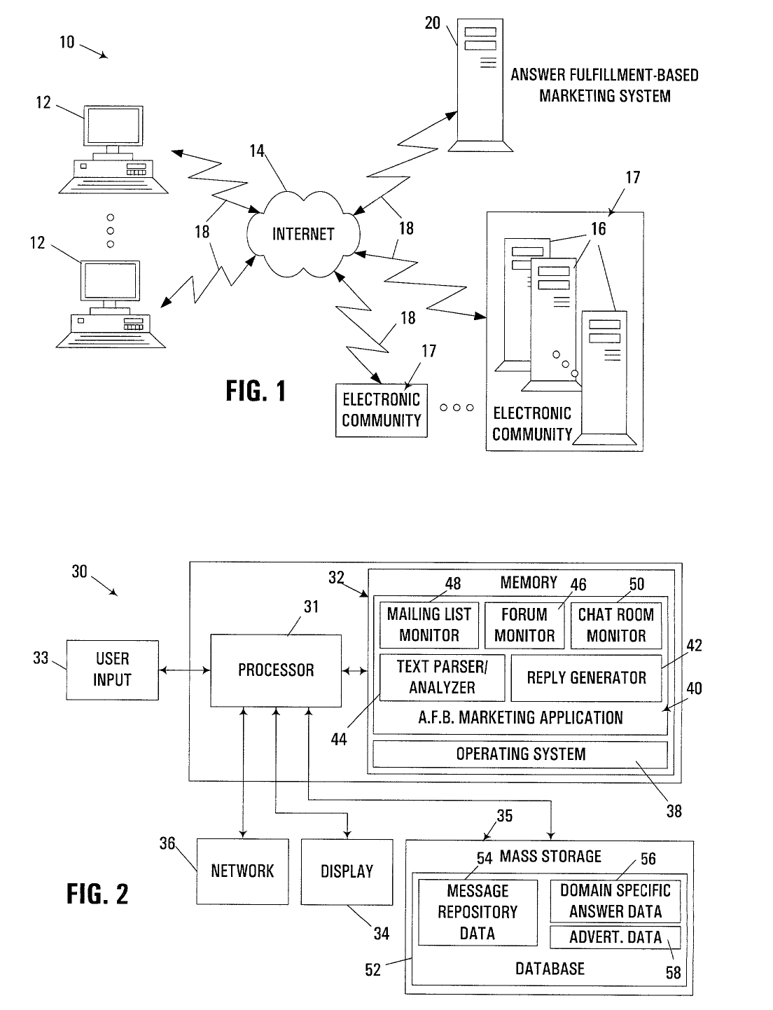

FIG. 1 is a block diagram of a networked computer system incorporating an answer fulfillment-based marketing system consistent with the invention.

FIG. 2 is a block diagram of an exemplary hardware and software implementation of the answer fulfillment-based marketing system of FIG. 1.

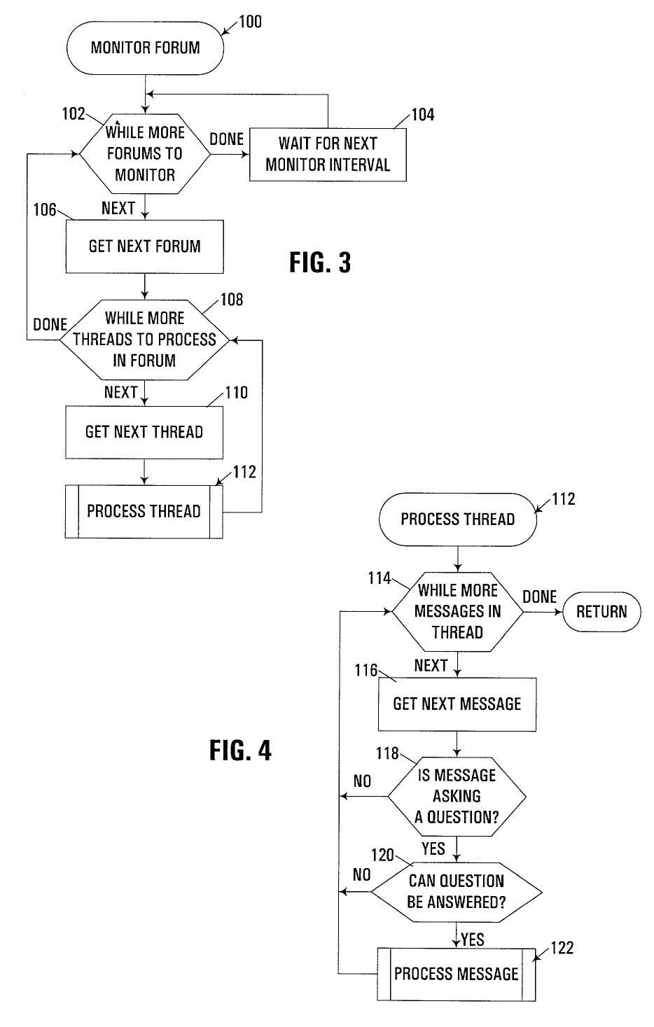

FIG. 3 illustrates the program flow of a monitor forum routine executed by the forum monitor of FIG. 2.

FIG. 4 illustrates the program flow of the process thread routine referenced in FIG. 3.

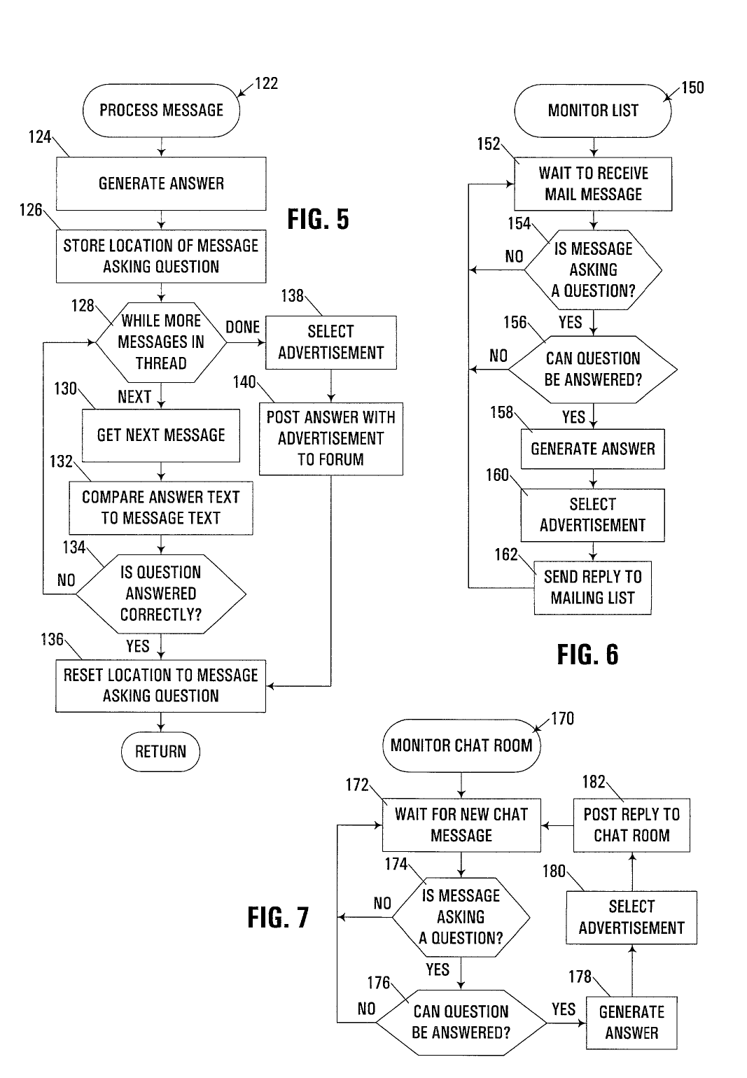

FIG. 5 illustrates the program flow of the process message routine referenced in FIG. 4.

FIG. 6 illustrates the program flow of a monitor list routine executed by the mailing list monitor of FIG. 2.

FIG. 7 illustrates the program flow of a monitor chat room routine executed by the chat room monitor of FIG. 2.

### DETAILED DESCRIPTION

The embodiments described herein utilize an automated answer fulfillment-based marketing system to provide automated marketing of a product or service in connection with answering queries posed in electronic messages associated with one or more electronic communities. The hereinafter-described embodiments generally operate by analyzing electronic messages for queries related to a particular topic or topics of interest, and then generating and sending replies to such messages that include both replies to the queries and advertisements related to the same topic of interest to which a particular query is directed.

A topic of interest may refer to practically any subject matter that end-users would typically have questions about, and that a particular product or service is relevant to for the purpose of marketing to end-users interested in that topic of interest. Topics of interest may range from relatively broad and far-reaching (e.g., cooking or sports trivia), to relatively narrow and specific (e.g., Using a Company X Food Processor, or Player X on Team Y). Given the wide range of products and services for which marketing may be desired, it should be appreciated that the topics of interest suitable for use in connection with answer fulfillment-based marketing are practically endless.

Moreover, the analysis techniques utilized herein are typically based upon messages that are associated with one or more electronic communities, or discussion areas, where multiple individuals interact with one another, and often where additional individuals that do not actually participate in an electronic “conversation” or exchange will also be able to “listen” to the conversation, either in real-time or at a later date (e.g., by searching through a message archive). As will become more apparent below, any number of electronic communities, including forums, mailing lists, chat rooms, message boards, bulleting boards, auction sites, etc., may be analyzed in the manner discussed herein.

Turning now to the Drawings, wherein like numbers denote like parts throughout the several views, FIG. 1 illustrates a computer system 10 consistent with the invention. Computer system 10 is illustrated as a networked computer system including one or more end-user computers 12 coupled via the Internet 14 to a plurality of message repositories 16 (representing one or more electronic communities 17) by way of one or more network links illustrated at 18. Each computer 12 is utilized by an end-users of one or more of the message repositories 16, e.g., forum or newsgroup members, mailing list members, chat room members, etc. To this extent, each computer 12 may be implemented by any type of computing or programmable electronic device capable of accessing a message repository and/or receiving electronic messages on behalf of a user, and optionally also capable of originating electronic messages to such a message repository, e.g., a desktop computer, a workstation, a laptop or portable computer, a handheld computer, a wireless telephone, or any other suitable form of networkable electronic device.

Each message repository 16, in turn, is typically capable of storing electronic messages on behalf of an electronic community for access by end-users, as well as by an answer fulfillment-based marketing system 20, discussed in greater detail below. Depending upon the type of electronic messages processed in connection with answer fulfillment-based marketing as described herein, each message repository can take a number of different forms. For example, for use in connection with electronic communities such as newsgroups or forums, a message repository 16 may be implemented as a forum or newsgroup server computer suitable for hosting one or more newsgroups or forums. Likewise, for electronic communities such as mailing lists, a message repository 16 may be configured as a listserv or other mailing list host. For electronic communities such as chat rooms, a message repository 16 may be an IRC or other compatible chat room host. Other types of electronic messages may be available for use in connection with answer fulfillment-based marketing consistent with the invention, e.g., instant messages. As such, other types of electronic communities and message repositories may be utilized consistent with the invention.

Furthermore, it will be appreciated that analysis of electronic messages in connection with answer fulfillment-based marketing may be performed by accessing a message repository via requests generated by answer fulfillment-based marketing system 20 and/or via transmission of electronic messages by a message repository to system 20 absent a specific request from system 20. For example, in the case of a mailing list, typically an answer fulfillment-based marketing system would be associated with an email address that is registered with a mailing list, such that any time a new message is posted to the mailing list, a copy is automatically forwarded to the email address for all members, including the answer fulfillment-based marketing system. In such an instance, the answer fulfillment-based marketing system may need to perform, at the most, an access to an email or groupware server to access a received message.

Likewise, in the environment of a chat room, content is generally “pushed” to active participants once those participants log on. In the case of answer fulfillment-based marketing, therefore, once a chat room is logged into, new messages are typically automatically pushed to an answer fulfillment-based marketing system by the chat room host.

It should also be appreciated that message analysis can be performed in a number of manners, e.g., in batches or via automated crawling (e.g., as would typically be the case for forum messages), or via access of messages received individually, even in near-real-time, by an answer fulfillment-based marketing system (e.g., as would typically be the case for mailing list and chat room messages). Moreover, in some instances, archives may exist of forum threads, mailing list messages or digests, chat room transcripts, etc., which may be searched for relevant queries as well.

It should further be appreciated that each network interconnection 18 may be implemented in a number of manners, e.g., through local-area, wide-area, wireless, private and/or public network interconnects (and combinations thereof). Moreover, FIG. 1 illustrates an embodiment where the message repositories 16 are publically accessible by all end-users as well as the answer fulfillment-based marketing system over the Internet 14. In other embodiments, any number of end-users, message repositories, and/or the answer fulfillment-based marketing system may be interconnected via private networks. In some instances, in fact, the Internet and/or a public network may not be used at all.

FIG. 2 illustrates an exemplary hardware and software environment for an apparatus 30 suitable for implementing answer fulfillment-based marketing consistent with the invention. For the purposes of the invention, apparatus 30 may represent practically any type of computer, computer system or other programmable electronic device, including a client computer, a server computer, a portable computer, a handheld computer, an embedded controller, etc. Moreover, apparatus 30 may be implemented using one or more networked computers, e.g., in a cluster or other distributed computing system. Apparatus 30 will hereinafter also be referred to as a “computer”, although it should be appreciated the term “apparatus” may also include other suitable programmable electronic devices consistent with the invention.

Computer 30 typically includes at least one processor 31 coupled to a memory 32. Processor 31 may represent one or more processors (e.g., microprocessors), and memory 32 may represent the random access memory (RAM) devices comprising the main storage of computer 30, as well as any supplemental levels of memory, e.g., cache memories, non-volatile or backup memories (e.g., programmable or flash memories), read-only memories, etc. In addition, memory 32 may be considered to include memory storage physically located elsewhere in computer 30, e.g., any cache memory in a processor 31, as well as any storage capacity used as a virtual memory, e.g., as stored on a mass storage device 35 or on another computer coupled to computer 30 via network 36.

Computer 30 also typically receives a number of inputs and outputs for communicating information externally. For interface with a user or operator, computer 30 typically includes one or more user input devices 33 (e.g., a keyboard, a mouse, a trackball, a joystick, a touchpad, and/or a microphone, among others) and a display 34 (e.g., a CRT monitor, an LCD display panel, and/or a speaker, among others). Otherwise, user input may be received via another computer interfaced with computer 30 over network 36.

For additional storage, computer 30 may also include one or more mass storage devices 35, e.g., a floppy or other removable disk drive, a hard disk drive, a direct access storage device (DASD), an optical drive (e.g., a CD drive, a DVD drive, etc.), and/or a tape drive, among others. Furthermore, computer 30 may include an interface with one or more networks 36 (e.g., a LAN, a WAN, a wireless network, and/or the Internet, among others) to permit the communication of information with other computers coupled to the network. It should be appreciated that computer 30 typically includes suitable analog and/or digital interfaces between processor 31 and each of components 32, 33, 34, 35 and 36 as is well known in the art.

Computer 30 operates under the control of an operating system 38, and executes or otherwise relies upon various computer software applications, components, programs, objects, modules, data structures, etc. (e.g., answer-fulfillment-based marketing application 40 shown resident in memory 32 and including reply generator 42, text parser/analyzer 44, forum monitor 46, mailing list monitor 48, and chat room monitor 50, as well as answer fulfillment database 52 shown resident in mass storage 35 and including message repository data 54, domain specific answer data 56 and advertising data 58, among others). Moreover, various applications, components, programs, objects, modules, etc. may also execute on one or more processors in another computer coupled to computer 30 via a network 36, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

In the illustrated embodiment, answer fulfillment-based marketing is implemented within a marketing application 40 as shown in FIG. 2. As discussed above, answer fulfillment-based marketing as described herein is based on the premise of locating electronic messages in electronic communities that incorporate queries related to a topic of interest, and then attempting to provide answers to such queries and advertise products or services at the same time.

To implement the functionality of locating electronic messages that incorporate queries directed to a topic of interest, application 40 typically utilizes one or more monitor programs, e.g., a forum monitor 46, a mailing list monitor 48 and/or a chat room monitor 50, to search available message repositories for relevant electronic messages. In connection with such monitoring functionality, message repository data 54 is stored in a database 52 associated with the application, providing a list of message repositories and topic parameters that define the overall search space to be monitored by the various monitoring programs resident in the application. Data 54 may also include locally-stored copies of electronic messages as well.

Further, given that a system may perform analysis services for the purpose of marketing more than one particular product or service at once, even on behalf of more than one product or service provider, multiple search spaces may be defined in data 54.

Monitoring of message repositories will typically vary depending upon the particular types of message repositories being searched, as well as the types of messages themselves. Moreover, precisely which message repositories and types of message repositories are analyzed can be configured by an operator as desired.

It should further be appreciated that the various monitor programs may be implemented in a number of manners. For example, a monitor program may simply access a remote message repository while resident in apparatus 30, e.g., via HTTP requests to such message repositories. Moreover, a monitor may be configured as a recipient of a particular message, e.g., in the case of a mailing list monitor or chat room monitor, whereby requests are typically not issued by the monitor. Furthermore, various monitor programs may be distributed and operate as intelligent agents that are transmitted to remote message repositories or other computing systems to perform their activities. Monitor programs may also be configured in a similar manner to conventional web crawlers that actively attempt to locate additional sources of electronic messages meeting the particular search space parameters defined in data 54. Individual monitor programs may analyze multiple electronic communities, or multiple monitor programs may be used to analyze multiple communities in some instances.

Application 40 may also include a text parser/analyzer program 44 that may be utilized by the various monitor programs in connection with both detecting queries, as well as detecting electronic messages and/or message repositories associated with a particular topic of interest. It is anticipated that a number of known text parsing and analysis algorithms may be utilized in this regard.

The generation of automated replies in response to the location of electronic messages containing relevant queries is supported by a reply generator program 42 in application 40. Generally, in response to detecting a relevant electronic message, the reply generator program generates a second electronic message containing both a reply to a query, as well as an advertisement associated with the topic of interest to which the query is directed. In connection with these activities, reply generator program 42 5 relies on domain specific answer data 56 and advertising data 58, both resident in database 52. The domain specific answer data is utilized in connection with the generation of a reply, and may include either the actual answer to a query, or text or other data that directs an originator of a query to a potential source of the answer (e.g., another web site). In addition, a combination of answers and sources of answers may be represented in data 56, as may general reply data that may be used whenever a specific answer to a particular query cannot be generated (e.g., “While I do not have the specific answer to your question, I note that this topic is discussed in detail at this web site.”)

Advertising data 58 is utilized by reply generator program 42 in producing an advertisement relevant to the topic of interest. It should be appreciated that the advertisement may include text, image, animation, video, audio and other forms of presentation data, and may also include various advertising content such as coupons, hypertext links for more information, links that enable a user to purchase a product or service, or any other known manner of presenting an advertisement. Data that maps advertisements to particular types of queries may also be included.

As discussed above, various types of electronic message repositories may be monitored and replied to in the manner discussed herein. FIGS. 3-5, for example, illustrate a monitor forum routine 100 that monitors electronic messages in an electronic community such as a newsgroup or public forum, and submits appropriate reply messages directly to the originator of a query and/or to the forum itself via a post in follow-up to a particular message. FIG. 6 illustrates a monitor list routine 150 that performs similar activities in connection with a mailing list electronic community, while FIG. 7 illustrates a monitor chat room routine 170 that performs similar functionality in connection with a chat room electronic community.

As shown in FIG. 3, for example, monitor forum routine 100 generally operates by performing a loop beginning at block 102 to process a plurality of forums to be monitored (typically defined in data 54). Upon completion of processing each relevant forum, block 102 proceeds to block 104 to wait for a next monitor interval, and repeat the monitoring process thereafter.

During each monitor interval, while more forums remain to be processed, block 102 passes control to block 106 to obtain the next forum to be analyzed, e.g., identified by the message repository data 54 in the database. Block 108 then initiates a loop to process each thread in the forum. As is well known in the art, newsgroups or forums are typically organized into threads that are generally directed to more specific issues than the general topic of interest to which a particular forum pertains. For each such thread, block 108 passes control to block 110 to obtain the next thread. Subsequently, a process thread routine 112, illustrated in greater detail in FIG. 4, is called. When all threads in a forum are processed, block 108 returns control to block 102 to process additional forums.

As shown in FIG. 4, process thread routine 112 begins in block 114 by initiating a loop to process each message in the thread. For each such message, control passes to block 116 to obtain the next message, and then to block 118 to determine whether the message is asking a question, i.e., posing a query.

Various manners of determining whether a message poses a query may be used in the illustrated implementation. For example, searching for question marks may be used to detect queries, as may searching for interrogative, or question-type, words such as “what,” “where,” “how,” etc. More sophisticated query detection algorithms, many of which are known in the art, may also be used. Various other text analysis, information extraction and question answering systems are known in the art, and the algorithms utilized in such systems may be used in connection with query detection consistent with the invention.

If it is determined that the message is not asking a question, block 118 returns control to block 114 to process additional messages in the thread. On the other hand, if a question is detected in the message, block 118 passes control to block 120 to determine where the question can be answered. For example, block 120 may determine whether the topic of interest to which the query pertains is relevant to the topic of interest that is defined by the search space for the forum monitor, i.e., whether the query is relevant to the particular marketing campaign being implemented using the herein-described system. On the other hand, the search space of forums that are analyzed may be limited to the topic of interest, whereby a determination of whether a query is directed to a particular topic of interest may not be required.

Block 120 may also determine whether a question can be answered in view of the available answer data stored in the database, i.e., whether an answer exists to the query.

If it is determined that the question cannot be answered, block 120 returns control to block 114 to process additional messages. Otherwise, block 120 calls a process message routine 122 to process the relevant message, which returns control to block 114 once completed. Once block 114 detects that all messages in a thread have been processed, routine 112 is complete.

Routine 122 is illustrated in greater detail in FIG. 5. The routine begins in block 124 by generating an answer. For example, the available domain specific answer data may be searched to determine an appropriate answer to a query, typically in response to analysis of the query using various information extraction algorithms such as discussed above. For example, various known search engine algorithms may be utilized to determine best fit matches to a particular query and answer, e.g., based upon keyword comparisons and the like. Also, as described above, block 124 may alternatively generate a pointer to the location of an answer, or even a message that indicates that the query cannot be answered directly, but that a particular information source may be used to answer the question.

Block 126 then stores the location of the message asking the question, for the purpose of returning to that message in subsequent iterations in the loop of routine 112 of FIG. 4.

Next, block 128 initiates an optional loop to process any additional messages in the thread. For each such additional message, control passes to block 130 to obtain the next message, and then to block 132 to compare the answer text with the message text, to determine whether the question has already been answered by another individual. For example, it may be desirable to perform text matching with the answer and message text to determine a degree of similarity, with a particular threshold used to determine when the answer has already been provided. Checking for another correct answer may be beneficial from the standpoint that posting an answer that has already been posted would likely be viewed unfavorably by readers, and thus would be best avoided.

Therefore, in response to the comparison made in block 132, block 134 then determines whether the question has already been answered correctly. If not, control passes to block 134 to process any additional messages in the thread. Otherwise, control passes to block 136 to reset the current location to the message that asked the question, and to return to routine 112 without sending a response message.

Returning to block 128, if it has been determined that no subsequent messages in the thread correctly answered the question, control passes to block 138 to select a suitable advertisement from the advertising data, e.g., based upon the particular query, or based upon simply selecting a single advertisement that is generated in response to all queries. Block 140 then posts the answer along with the advertisement to the forum, typically as an additional post in the same thread. In the alternative, or in addition to posting to the forum, an email message may be sent directly to the originator of the query. In the case of posting the answer to the forum, however, it is anticipated that the advertisement, along with the associated answer to the query, will be viewed by a greater number of relevant individuals. Thus, in connection with directly answering a query and providing an advertisement to the originator of the query, other individuals that later view the thread based upon an interest in the query will also view the advertisement and the answer. After the answer is posted, block 136 resets the current location to the message that asked the question. Control then returns to routine 112 of FIG. 4.

FIG. 6 next illustrates monitor list routine 150 in greater detail. In this embodiment, routine 150 may be implemented as an agent dedicated to a particular mailing list, and configured to receive mail messages directed to an email address with which the marketing application is associated with in the mailing list. Thus, a separate agent would be required for each mailing list being monitored in this implementation. On the other hand, multiple mailing lists may be monitored by the same monitor program in the alternative.

Routine 150 operates by waiting in block 152 to receive a mail message from the mailing list to which the application is subscribed. In response to receiving such a message, block 154 is executed to determine whether the message is asking a question, similar to the manner described above in connection with block 118 of routine 112. If not, control returns to block 152 to wait for additional messages. Otherwise, control passes to block 156 to determine whether the question can be answered. As above, block 156 may be implemented in a similar manner to block 120 of routine 112.

If the question cannot be answered, control returns to block 152 to wait for additional messages. Otherwise, control passes to block 158 to generate an answer, and then to block 160 to select an appropriate advertisement. Block 162 then sends a reply to the mailing list containing the answer and selected advertisement, e.g., by directing an email to the mailing list and/or to the email address of the query originator. Control then returns to block 152.

It should be appreciated that blocks 158 and 160 may be implemented in a similar manner to blocks 124 and 138 of routine 122. Moreover, it should be appreciated that determination of whether a question has already been answered may also be implemented in routine 150, although it is anticipated that in many instances, the automated nature of routine 150 will result in the generation in a suitable answer before any human mailing list recipient could reply to a particular query presented in a mailing list message.

FIG. 7 illustrates monitor chat room routine 170 in greater detail, which similar to routine 150 is configured for monitoring a particular chat room. In the alternative, a routine that monitors multiple chat rooms may also be used.

Routine 170 begins in block 172 by waiting for a new chat message, e.g., by waiting for a refreshed HTML page in the case of an HTML-based chat system, or waiting for a new message as in the case of an IRC chat room. Upon receipt of such a message, block 174 determines whether the message is asking a question, and block 176 determines whether the question can be answered, each similar to the aforementioned corresponding blocks in routine 150. If either determination is negative, control returns to block 172 to wait for additional chat messages. Otherwise, control passes to block 178 to generate an answer, and then to block 180 to select an advertisement. Block 182 then posts a reply to the chat room containing both the answer and the advertisement. Blocks 178-182 may therefore be configured similar to the corresponding blocks in routine 150.

In use, the herein-described answer fulfillment-based marketing system implementation may be used to conduct a marketing campaign in the following manner. First, an operator defines the parameters of the marketing campaign, e.g., defining a search space consisting of the particular electronic communities to be searched, as well as the type of message repositories and electronic messages to be analyzed in those communities. In addition, parameters such as the types of queries to be answered, mappings of answers to particular queries, and the types of advertisements to map to particular answers may also be defined. After defining the marketing campaign parameters, the application is suitably configured by the operator, e.g., through any number of known user interfaces. In addition, where particular monitors are used to monitor chat rooms, mailing lists and like message repositories, additional subscription activities may be performed, e.g., to register an email address associated with the application with a mailing list, or to subscribe and log into a particular chat room. Further, where a forum requires membership to post, a monitor may also be registered or subscribed in any appropriate forums as desired. Routines 100, 150 and 170 may also be configured to perform such activities on initialization.

Once the application is suitably configured, a marketing campaign may be initiated, with the various monitors enabled to search for relevant messages containing queries directed to the particular topic of interest. For any detected messages, replies are generated and sent in the manner described above.

It will be appreciated that the herein-described marketing techniques may be used to respond to queries directed to a wide variety of topics of interest. Thus, for example, queries may be related to topics such as trivia, history, entertainment, sports, education, guides, travel, restaurants, business ratings, recipes, technical issues, product specifications, product operation, user support and service, hobbies, etc.

Moreover, the herein-described marketing techniques may be used to generate any number of advertisements on behalf of various types of advertisers, e.g., operators of web sites to increase subscriptions or to increase viewership, selling products or services such as computer programs, books, movies, television programs, television stations, consumer goods, etc. It should be appreciated, however, that the above lists are not exclusive, as the types of queries, topics of interest, advertisements and advertisers may find benefit in the herein-described marketing techniques.

By way of a non-limiting example, consider a provider of a cooking/recipe software program. The herein-described marketing techniques could be used to scan the Internet looking for electronic messages where people are asking for particular recipes. Text analysis of the messages could detect queries using keywords or phrases such as “does anyone have the recipe for” or “how do you make” in a certain context, or simply looking for keywords in association with a question mark. After optionally determining whether an answer has already been posted to the query, an answer could be posted with the requested recipe (if found in the database for the recipe software program) and include an advertisement such as “this recipe can be found in Bob's Cajun Cooking complete software available for $19.99 at http://www.BobsCajunCooking.com.”

In a similar manner, a sporting web site could use the herein-described techniques to advertise its site, while answering sporting trivia posts. Thus, if someone wants to know how many home runs Player X hit in 1999, a reply could be posted with the correct answer, and the advertisement “for the best sports statistics, go to http://www.BobsSportsFacts.com.” In addition, in either instance, it may be desirable to provide a coupon or a link to additional materials or to offer promotional items such as a discount, a sale price, a special offer, or the like.

As discussed above, one advantage in many embodiments is that replies would often not only be seen by the person who had originally posted a query, but others who read the query (and its related answer) as well. Thus, a greater advertising audience can be obtained for an advertisement than were a message only sent to and viewed by the originator of the query.

From the perspective of an operator of an answer fulfillment-based marketing system who is not the provider of the product or services to be advertised, another advantage is that other entities desiring to market their particular products or services could be provided such services in exchange for a registration fee, and that the products/services of multiple entities could be advertised using the same system. Thus, it should be appreciated that the provider of a product or service need not necessarily be the same entity that operates an answer fulfillment-based marketing system consistent with the invention.

Various modifications may be made to the illustrated embodiments without departing from the spirit and scope of the invention. For example, in some embodiments it may not be necessary to reply to an electronic message that includes a query using the same type of electronic message. For example, if it is possible to determine the email address of a mailing list member, chat room participant or forum member, an email may be sent directly to that user rather than replying in the same format as the electronic message containing the query. As another alternative, in some instances it may be desirable to utilize some degree of manual intervention, e.g., to determine whether an electronic message contains a query in a particular instance, what the appropriate answer is to a located query, or what advertisement is appropriate for a particular query. Thus, operator feedback could be solicited by the application from time to time. Various non-linear logic and learning techniques may also be utilized to improve a marketing system's analysis techniques and train a marketing system to incorporate additional knowledge over time as well.

Other modifications will be apparent to one of ordinary skill in the art. Therefore, the invention lies in the claims hereinafter appended.

What is claimed is:

1. A computer-implemented method of advertising, comprising:
(a) searching a plurality of electronic messages associated with at least one electronic community to locate a first electronic message including a query directed to a topic of interest; and
(b) subsequent to locating the first electronic message, sending a second electronic message including a reply to the query and an advertisement related to the topic of interest to which the query is directed.

2. The method of claim 1, wherein sending the second electronic message includes sending the second electronic message to an originator of the first electronic message.

3. The method of claim 1, wherein searching the plurality of electronic messages includes searching at least one electronic message repository associated with the electronic community.

4. The method of claim 3, wherein searching the plurality of electronic messages includes searching a plurality of electronic message repositories associated with a plurality of electronic communities.

5. The method of claim 3, wherein the electronic message repository is accessible by a plurality of individuals, and wherein sending the second electronic message includes posting the second electronic message on the electronic message repository for viewing by the plurality of individuals.

6. The method of claim 3, wherein searching the plurality of electronic messages includes receiving the plurality of messages from the electronic message repository over a public communications network.

7. The method of claim 1, wherein searching the plurality of electronic messages includes receiving the plurality of messages based upon membership in the electronic community.

8. The method of claim 1, wherein the reply includes an answer to the query.

9. The method of claim 1, wherein the reply identifies to a reader of the second electronic message an information source from which the answer may be obtained.

10. The method of claim 1, wherein at least a subset of electronic messages in the plurality of electronic messages comprise posts associated with a forum electronic community, and wherein the second electronic message comprises a reply post.

11. The method of claim 1, wherein at least a subset of electronic messages in the plurality of electronic messages comprise email messages associated with a mailing list electronic community, and wherein the second electronic message comprises a reply email message.

12. The method of claim 1, wherein at least a subset of electronic messages in the plurality of electronic messages comprise chat messages associated with a chat room electronic community, and wherein the second electronic message comprises a reply chat message.

13. The method of claim 1, wherein the plurality of electronic messages are associated with at least one electronic community selected from the group consisting of a forum, a chat room, a mailing list, and combinations thereof.

14. The method of claim 1, further comprising determining whether the query is capable of being answered, wherein sending the second electronic message is performed if it is determined that the query is capable of being answered.

15. The method of claim 1, further comprising determining whether the query has already been answered, wherein sending the second electronic message is performed if it is determined that the query has not yet been answered.

16. The method of claim 1, wherein sending the second electronic message includes selecting an advertisement from a plurality of advertisements based upon the query.

17. An apparatus, comprising:
(a) at least one processor; and
(b) program code configured to be executed on the at least one processor to search a plurality of electronic messages associated with at least one electronic community to locate a first electronic message including a query directed to a topic of interest; and, subsequent to locating the first electronic message, send a second electronic message including a reply to the query and an advertisement related to the topic of interest to which the query is directed.

18. The apparatus of claim 17, wherein the program code is configured to send the second electronic message to an originator of the first electronic message.

19. The apparatus of claim 17, wherein the program code is configured to search the plurality of electronic messages by searching at least one electronic message repository associated with the electronic community.

20. The apparatus of claim 19, wherein the electronic message repository is accessible by a plurality of individuals, and wherein the program code is configured to send the second electronic message by posting the second electronic message on the electronic message repository for viewing by the plurality of individuals.

21. The apparatus of claim 19, wherein the program code is configured to search the plurality of electronic messages by accessing the electronic message repository over a public communications network.

22. The apparatus of claim 17, wherein the program code is configured to subscribe to the electronic community such that the plurality of messages are received based upon membership in the electronic community.

23. The apparatus of claim 17, wherein the reply includes an answer to the query.

24. The apparatus of claim 17, wherein the reply identifies to a reader of the second electronic message an information source from which the answer may be obtained.

25. The apparatus of claim 17, wherein at least a subset of electronic messages in the plurality of electronic messages comprise posts associated with a forum electronic community, and wherein the second electronic message comprises a reply post.

26. The apparatus of claim 17, wherein at least a subset of electronic messages in the plurality of electronic messages comprise email messages associated with a mailing list electronic community, and wherein the second electronic message comprises a reply email message.

27. The apparatus of claim 17, wherein at least a subset of electronic messages in the plurality of electronic messages comprise chat messages associated with a chat room electronic community, and wherein the second electronic message comprises a reply chat message.

28. The apparatus of claim 17, wherein the program code is further configured to determine whether the query is capable of being answered.

29. The apparatus of claim 17, wherein the program code is further configured to determine whether the query has already been answered.

30. The apparatus of claim 17, wherein the program code is configured to select the advertisement from a plurality of advertisements based upon the query.

31. A program product, comprising:
(a) program code configured to search a plurality of electronic messages associated with at least one electronic community to locate a first electronic message including a query directed to a topic of interest; and, subsequent to locating the first electronic message, send a second electronic message including a reply to the query and an advertisement related to the topic of interest to which the query is directed; and
(b) a signal bearing medium bearing the program code.

32. The program product of claim 31, wherein the signal bearing medium includes at least one of a recordable medium and a transmission medium.
